(19) United States
(12) Patent Application Publication
(10) Pub. No.: US 2012/0075846 A1
(43) Pub. Date: Mar. 29, 2012

(54) TWO-COLOR MIXING LED ILLUMINATING DEVICE

(75) Inventors: SHAO-HAN CHANG, Tu-Cheng (TW); XIAO-MAN PU, Shenzhen City (CN); SU-TZONG LIU, Tu-Cheng (TW)

(73) Assignees: HON HAI PRECISION INDUSTRY CO., LTD., Tu Cheng (TW); HONG FU JIN PRECISION INDUSTRY (ShenZhen) CO., LTD., ShenZhen City (CN)

(21) Appl. No.: 13/090,276

(22) Filed: Apr. 20, 2011

(30) Foreign Application Priority Data
Sep. 24, 2010 (CN) 201010289235.9

(51) Int. Cl. F21V 5/02

(52) U.S. Cl. 362/231

(57) ABSTRACT

An LED illuminating device comprises a housing with a base plate, a prism sheet and a circuit board. The prism sheet is mounted in the housing and comprises a number of V-shaped micro-grooves formed thereon along four directions intersecting with each other. The circuit board is fixed on the base plate, wherein a plurality of LED units is arranged on the circuit board. Each two adjacent LED units are spaced a preset distance and emit light of different colors. Eight virtual mixed light sources are formed by reflection of the prism sheet to the circuit board when the light emitted by one of the LED units mixes with light emitted from adjacent LED units on the circuit board. Each of the virtual mixed light sources has a color different from the colors of the light emitted from the LED units.

### CROSS-REFERENCES TO RELATED APPLICATIONS

Related subject matter is disclosed in a co-pending U.S. patent application with an Attorney Docket Number of US36006 and a title of TWO-COLOR MIXING LED ILLUMINATING DEVICE, which has the same assignee as the current application and was concurrently filed.

### BACKGROUND

1. Technical Field

The present disclosure relates to light emitting diode (LED) illuminating devices, especially to a two-color mixing LED illuminating device.

2. Description of Related Art

Compared to many other kinds of illuminating devices, LED illuminating devices have many advantages, such as high luminous efficiency, low power consumption, and long service life. Even still, LED lights have disadvantages. The range of colors currently available for LEDs is limited. LEDs only come in a few basic colors, which cannot satisfy the needs of different users in particular applications.

Therefore, what is needed is an LED illuminating device that can overcome the above mentioned limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross-sectional view of an LED illuminating device according to an embodiment.

FIG. 2 is an isometric view of a prism sheet of the LED illuminating device of FIG. 1.

FIG. 3 is a schematic, side view showing the LED illuminating device that forms a plurality of virtual light sources.

FIG. 4 is a schematic, planar view showing the virtual light sources formed by an LED unit of FIG. 1.

FIG. 5 is a schematic, planar view showing the virtual light sources formed by two-color LED units of FIG. 1.

FIG. 6 is a schematic view of the virtual light sources arrays formed by a plurality of LED units of FIG. 1.

### DETAILED DESCRIPTION

Embodiments of the present disclosure will now be described in detail below, with reference to the accompanying drawings.

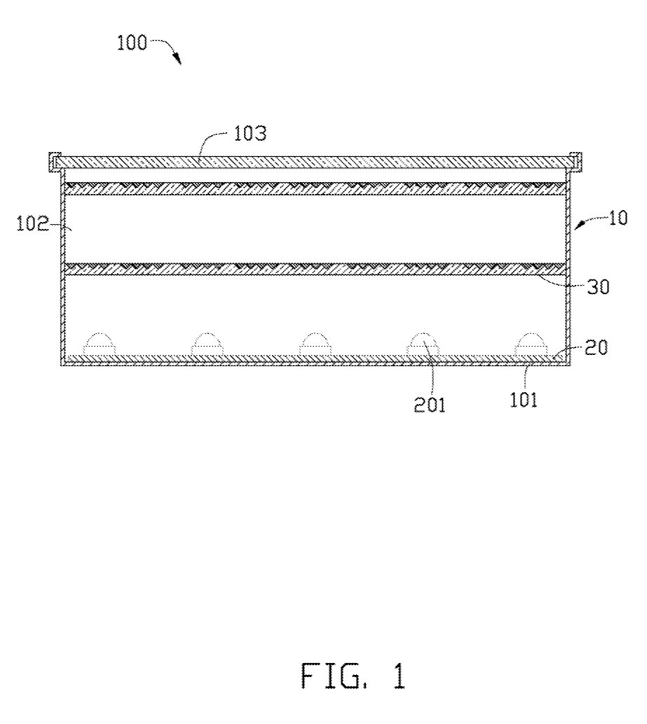

Referring to FIG. 1, a light emitting diode (LED) illuminating device 100 according to an embodiment is disclosed. The LED illuminating device 100 includes a housing 10, a circuit board 20, and a prism sheet 30. A number of LED units 201 are arranged on the circuit board 20. The housing 10 includes a base plate 101, a sidewall 102 surrounding the base plate 101, and a protective cover 103. The circuit board 20 is fixed on the base plate 101, and the prism sheet 30 is arranged above the circuit board 20 and substantially parallel to the circuit board 20. The protective cover 103 is fixed on the sidewall 102 and placed above the prism sheet 30 for protecting the prism sheet 30 and the circuit board 20 from being contaminated and damaged. In the embodiment, the protective cover 103 is made of transparent glass or transparent plastic plates. The base plate 101 and the sidewall 102 are made of metal or plastic having high reflectivity.

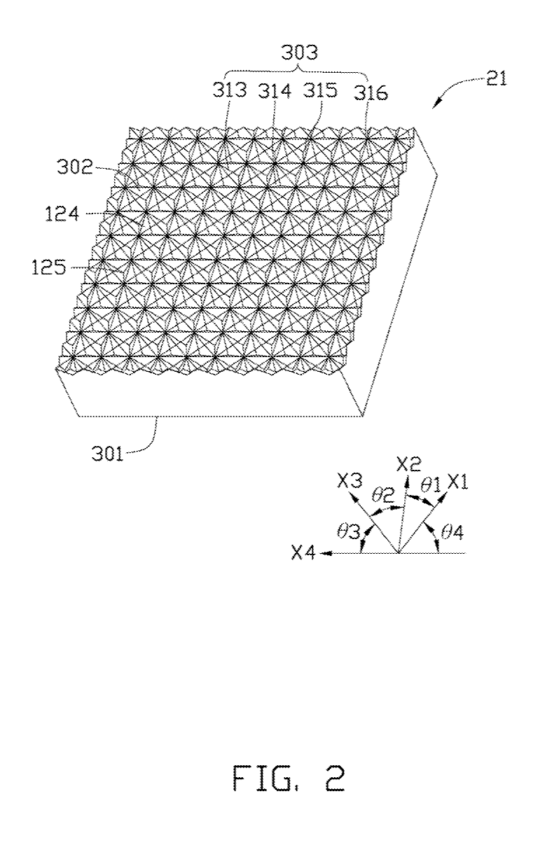

Referring to FIG. 2, the prism sheet 30 is made of transparent plastic and includes a light incident surface 301 and a light exit surface 302 opposite to the light incident surface 301. The light incident surface 301 is planar and faces the circuit board 20. A number of V-shaped micro-grooves 303 are formed on the light exit surface 302 along four directions, and the four directions of the V-shaped micro-grooves 303 intersect with each other. In the embodiment, an angle between each two adjacent extending directions of the micro-grooves 303 is about 45 degrees. The V-shaped micro-grooves 303 include a first type of V-shaped micro-grooves 313 extending along a first direction X1, a second type of V-shaped micro-grooves 314 extending along a second direction X2, a third type of V-shaped micro-grooves 315 extending along a third direction X3, and a forth type of V-shaped micro-grooves 316 extending along a forth direction X4 intersecting with the first direction Xl, the second direction X2 and the third direction X3. The micro-grooves 303 extending along four directions intersect with each other to form a number of triangular pyramids 124. Each four triangular pyramids 124 form a four-point star 125 at their intersections.

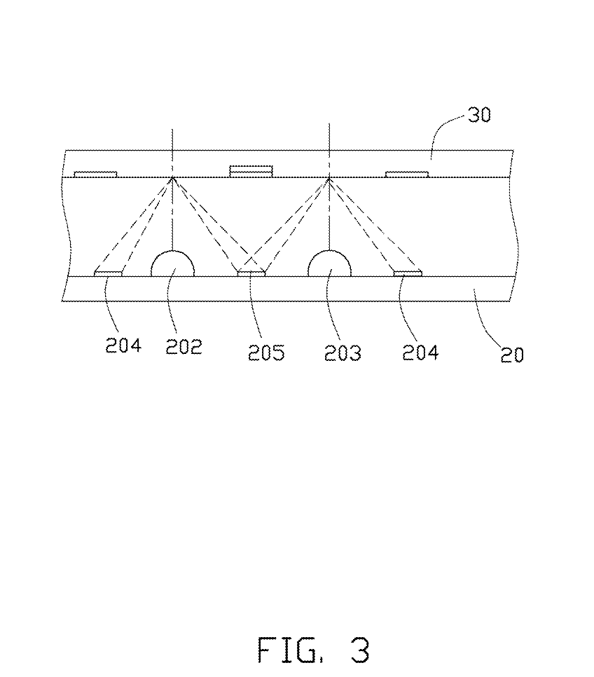

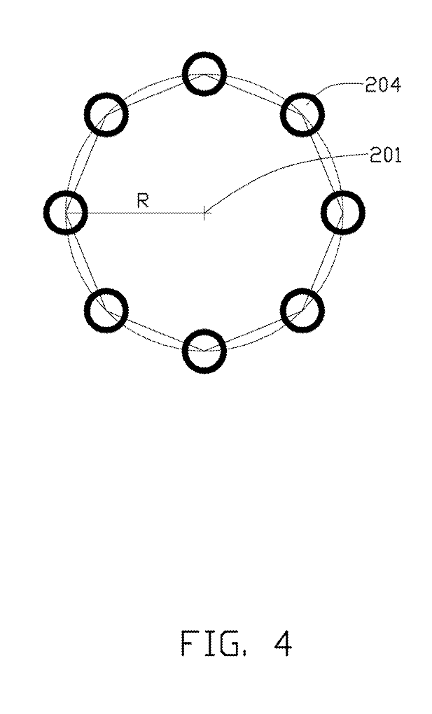

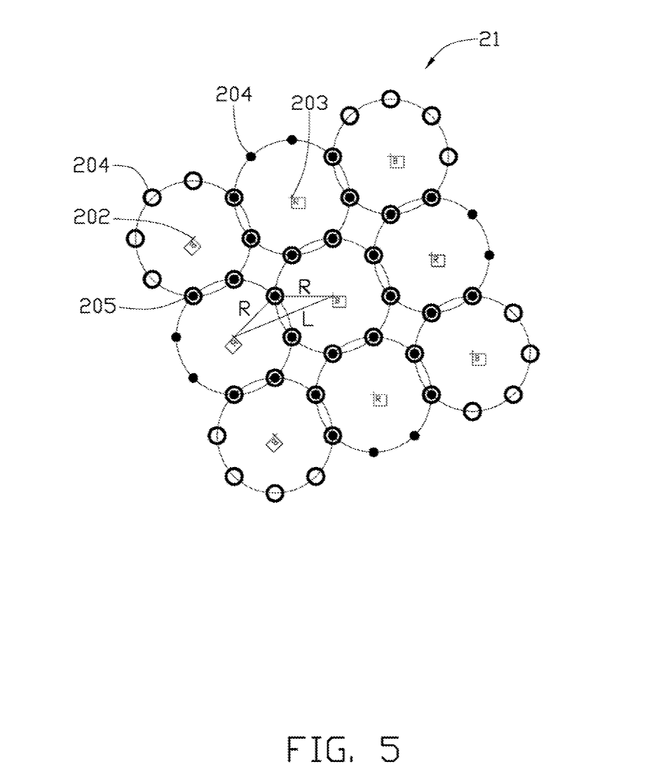

Referring to FIGS. 3-5, the LED units 201 are arranged in a matrix. The LEDs 201 include a number of first LED units 202 emitting light of a first color, and a number of LED units 203 emitting light of a second color different from the first color. The LED units 201 are arranged in a staggered fashion and any two adjacent LED units 201 emit different colors. Eight virtual light sources 204 are reflected to the circuit board 20 by eight triangular pyramids 124 of the prism sheet 30 when a particular LED unit 201 emits the light. The eight virtual light sources 204 are generally distributed on a circle, which has a center aligned with the particular LED unit 201. The value of the radius R of the circle is influenced by the distance between the prism sheet 30 and the LED units 201. Each two adjacent LED units 201 are spaced a preset distance L apart, eight virtual mixed light sources 205 are formed on the circuit board 20 when the light emitted by an LED unit 201 mixes with light emitted by four adjacent LED units 201 on the circuit board 20. In the embodiment, the preset distance L between each two adjacent LED units 201 is equal to R*cos22.5°. The one color different from the light emitted from each LED units can be selected for emission by the device 100 according to which two colors of LED units 201 are selected for mixing.

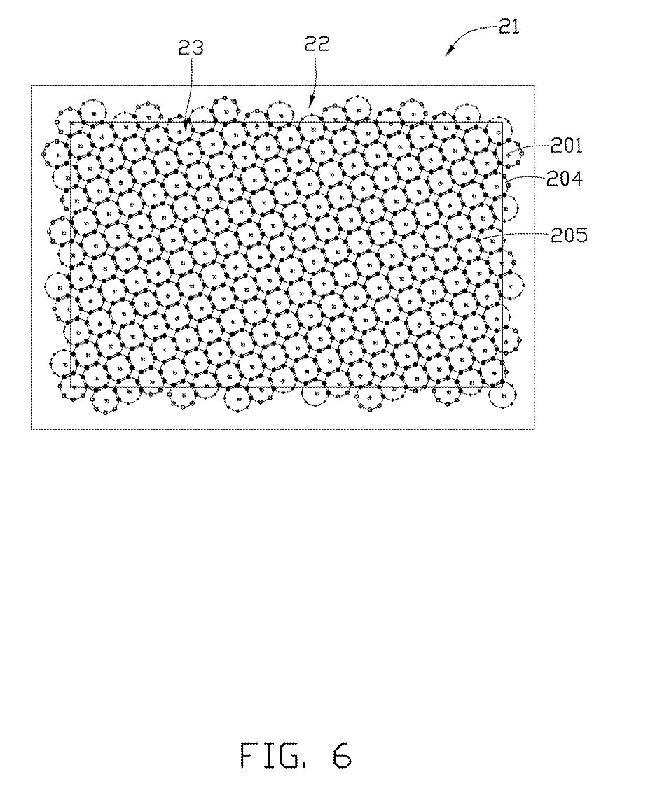

Referring to FIG. 6, a virtual light source array is formed. The virtual light source array includes a mixed light area 23 and a non-mixed light area 22 around the mixed light area 23.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An LED illuminating device comprising:
a housing comprising a base plate;
a prism sheet mounted in the housing and comprising a plurality of V-shaped micro-grooves formed thereon along four directions intersecting with each other;
a circuit board fixed on the base plate, wherein a plurality of LED units are arranged on the circuit board, each two adjacent LED units are spaced a preset distance apart from each other and emit light of different colors; eight virtual mixed light sources are formed by reflection of the prism sheet to the circuit board when the light emitted by a particular one of the LED units mixes with light emitted by adjacent LED units on circuit board, each of the virtual mixed light sources has a color different from the colors of the light emitted from the LED units.

2. The LED illuminating device of claim 1, wherein the prism sheet comprises a light incident surface and a light exit surface opposite to the light incident surface; the light incident surface is planar and faces the circuit board; the plurality of V-shaped micro-grooves are formed on the light exit surface.

3. The LED illuminating device of claim 1, wherein the V-shaped micro-grooves comprise a plurality of a first type of V-shaped micro-grooves extending along a first direction, a plurality of a second type of V-shaped micro-grooves extending along a second direction, a third type of V-shaped micro-grooves extending along a third direction, and a forth type of V-shaped micro-grooves extending along a forth direction intersecting with the first direction, the second direction and the forth direction.

4. The LED illuminating device of claim 1, wherein the prism sheet is made of transparent plastic.

5. The LED illuminating device of claim 1, wherein the housing comprises a side wall extending around the base plate, the circuit board is fixed on the base plate, the prism sheet is arranged above the circuit board.

6. The LED illuminating device of claim 1, wherein the prism sheet is substantially parallel to the circuit board.

7. The LED illuminating device of claim 1, further comprising a protective cover, wherein the protective cover is fixed on the sidewall above the prism sheet for protecting the prism sheet and the circuit board from being contaminated and damaged.

8. The LED illuminating device of claim 1, wherein an angle between two sides of each V-shaped micro-groove is about 45 degrees.

9. The LED illuminating device of claim 5, wherein the base plate and the sidewall are made of metal or plastic having high reflectivity.

10. The LED illuminating device of claim 1, wherein the eight virtual light sources are distributed on a circle, which has a center aligned the particular LED unit, the radius R of the circle is influenced by the distance between the prism sheet and the LED units.

11. The LED illuminating device of claim 10, wherein the preset distance between each adjacent two LED units is cos22.5° times of the value of the radius of the circle.
